(19) United States
(12) Patent Application Publication
(10) Pub. No.: US 2019/0040543 A1
(43) Pub. Date: Feb. 7, 2019

(54) METAL SURFACE MODIFICATION APPARATUS

(71) Applicant: GUANGDONG UNIVERSITY OF TECHNOLOGY, GUANGZHOU (CN)

(72) Inventors: Junfeng HE, GUANGZHOU (CN); Zhongning GUO, GUANGZHOU (CN); Li LIU, GUANGZHOU (CN)

(73) Assignee: GUANGDONG UNIVERSITY OF TECHNOLOGY

(21) Appl. No.: 16/153,775

(22) Filed: Oct. 7, 2018

Related U.S. Application Data
(63) Continuation of application No. PCT/CN2017/111269, filed on Nov. 16, 2017.

(30) Foreign Application Priority Data
Apr. 25, 2017 (CN) 201710277868.X
Apr. 25, 2017 (CN) 201720443502.0

(51) Int. Cl. C25D 13/22; C25D 15/00; C25D 21/02; C25D 21/12; H04N 5/372

(52) U.S. Cl. CPC C25D 13/22; C25D 15/00; B82Y 30/00; C25D 21/12; H04N 5/372; C25D 21/02

(57) ABSTRACT

A metal surface modification apparatus, includes: a particle and solution mixing and circulating system used for providing nanoparticle solution for a workpiece; a rotating platform used for fixing the workpiece and driving the workpiece to rotate; an electrophoresis system used for depositing particles in the nanoparticle solution in the particle and solution mixing and circulating system to a surface of the workpiece according to an electrophoretic effect; and a temperature control apparatus used for changing a surface temperature of the workpiece. The metal surface modification apparatus provided in the present disclosure may perform hydrophilic and hydrophobic modification treatment on a metal surface by combining one or more different processes.

### CROSS-REFERENCE TO RELATED APPLICATIONS

This application is a continuation of international application PCT/CN2017/111269, filed Nov. 16 2017, further claims priority to Chinese Patent Application No. 201710277868.X and Chinese Patent Application No. 201720443502.0 both with a filing date of Apr. 25, 2017. The content of the aforementioned applications, including any intervening amendments thereto, are incorporated herein by reference.

### TECHNICAL FIELD

The prevent disclosure relates to the technical field of material application, and particularly to a metal surface modification apparatus.

### BACKGROUND OF THE PRESENT INVENTION

With rapid development of modern sciences and technologies, there is an increasing requirement to the surface properties of metal materials, so that new development and extension for a surface treatment technology and process have been made. Surface modification for a hydrophilic bionic structure, a hydrophobic bionic structure and the like on the surface of a metal workpiece is a relatively popular surface processing technology.

Common methods for material surface modification in the prior art include a thermal sintering method, a nickel salt thermal decomposition method and the like. However, these methods may have the following technical problems: high-temperature treatment is required, resulting in relatively high cost, and modification substances may be attached unevenly in the soaking process, easily resulting in non-uniformity of the hydrophilicity and hydrophobicity properties on the surface of a treated carbon material. The nickel salt thermal decomposition method is not applicable to matrix materials with relatively low melting point and is only applicable to heat resistant substances such as ceramic, glass and carbonate silicon. Therefore, modification processes and apparatuses in the prior art usually do not have the universal applicability.

In conclusion, how to provide a modification apparatus with wide applicability is a problem that is required to be solved by those skilled in the art at present.

### SUMMARY OF PRESENT INVENTION

In view of this, the present disclosure aims to provide a metal surface modification apparatus. The metal surface modification apparatus may perform various types of modification treatment, and is convenient to use and relatively high in applicability.

To achieve the above-mentioned aim, the present disclosure provides the following technical solution:

A metal surface modification apparatus includes: a particle and solution mixing and circulating system, used for providing nanoparticle solution for a workpiece; a rotating platform, used for fixing the workpiece and driving the workpiece to rotate; an electrophoresis system, used for depositing particles in the nanoparticle solution in the particle and solution mixing and circulating system to a surface of the workpiece according to an electrophoretic effect; and a temperature control apparatus, used for changing a surface temperature of the workpiece.

Preferably, the particle and solution mixing and circulating system includes: a particle and solution mixing container, provided with a suction pipe and a suction pipe clamp which are used for providing the nanoparticle solution for the workpiece, wherein the suction pipe is used for sucking the nanoparticle solution to the surface of the workpiece; and one or more of a vibration apparatus, a magnetic stirring apparatus, a suspension suction apparatus and a solution circulating apparatus.

Preferably, the electrophoresis system includes: an electrophoresis-aided cathode clamp, connected to an electrophoresis-aided cathode, wherein the electrophoresis-aided cathode is arranged on the electrophoresis-aided cathode clamp, the electrophoresis-aided cathode clamp of the electrophoresis-aided cathode is connected to a machine tool main shaft, and the machine tool main shaft is used for controlling a distance between the electrophoresis-aided cathode and the workpiece; and an electrophoresis-aided system, wherein an output of the electrophoresis-aided system is connected with the electrophoresis-aided cathode and the workpiece respectively.

Preferably, the rotating platform is arranged on a micro three-dimensional motion platform capable of moving along three dimensional directions. The micro three-dimensional motion platform corresponds to a vertical position of the machine tool main shaft.

Preferably, the metal surface modification apparatus further includes a movable mask, used for covering part of the surface of the workpiece to realize partial insulation treatment. The movable mask is a movable insulating mask.

Preferably, the temperature control apparatus includes a vacuum control module or an auxiliary gas control module.

Preferably, an auxiliary control system of the electrophoresis system, the rotating platform and the particle and solution mixing and circulating system are connected with an integrated control cabinet.

Preferably, the auxiliary control system is integrated on a machine tool.

Preferably, the metal surface modification apparatus further includes a CCD (Charge Coupled Device) video detection system used for detecting a deposition condition on the surface of the workpiece and a distribution condition of particles in a molten state.

The metal surface modification apparatus provided by the present disclosure may perform hydrophilic and hydrophobic modification treatment on a metal surface by combining one or more different processes. A natural deposition method, a spin-coating method or an electrophoretic deposition method may be used for assisting micro-nano particles in surface treatment of any irregular metal surfaces such as a plane, a curved surface, a boss and a groove, so as to obtain an ordered micro particle arrangement on the metal surfaces to realize the surface modification. A binding force of micro-nano modified particles and the surface of the workpiece may be further enhanced by changing the surface temperature of the workpiece through heating equipment. The metal surface modification apparatus provided by the present disclosure is wide in application range, high in modification efficiency and convenient in use.

### DESCRIPTION OF THE DRAWINGS

To describe embodiments of the present disclosure or technical solutions in the prior art more clearly, drawings required to be used in descriptions of the embodiments or the prior art will be briefly introduced below. Apparently, the drawings in the descriptions below are only the embodiments of the present disclosure. Those ordinary skilled in the art can also obtain other drawings according to the provided drawings without contributing creative work.

FIG. 1 is a schematic diagram of a metal surface modification apparatus according to the present disclosure.

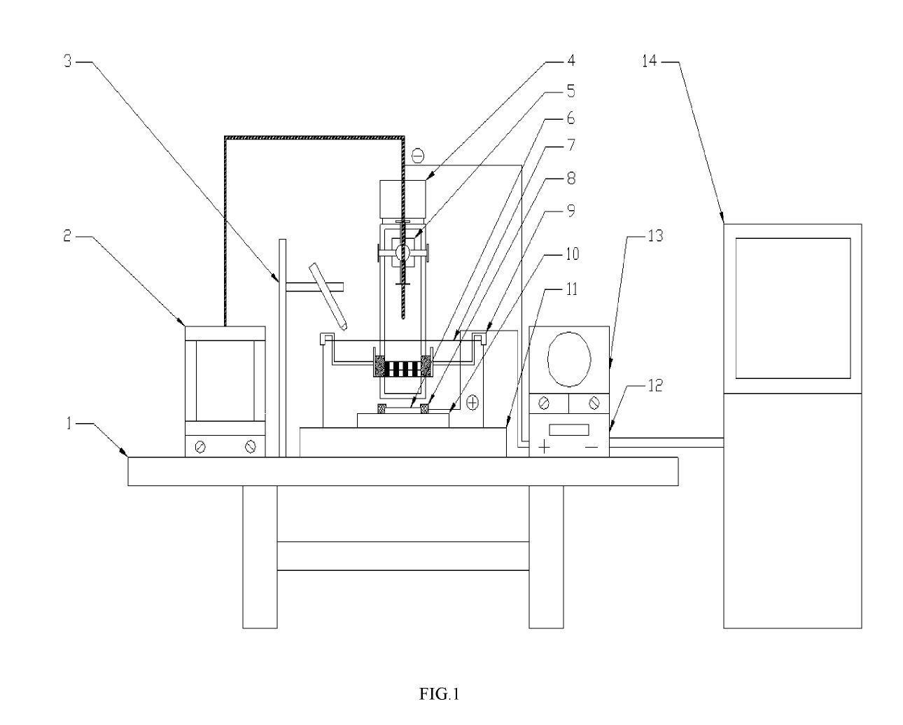

In FIG. 1:

1: machine tool; 2: particle and solution mixing and circulating system; 3: CCD (Charge Coupled Device) online video detection system; 4: machine tool main shaft; 5: electrophoresis-aided cathode clamp; 6: metal workpiece to be processed; 7: processing tank; 8: workpiece clamp; 9: movable mask and control system thereof; 10: rotation control system; 11: micro three-dimensional motion platform; 12: electrophoresis-aided system; 13: vacuum and temperature control system; and 14: integrated control cabinet.

### DETAILED DESCRIPTION OF PREFERRED EMBODIMENTS

Technical solutions in embodiments of the present disclosure will be described clearly and completely below in combination with the drawings in the embodiments of the present disclosure. Apparently, the embodiments described herein are only part of the embodiments of the present disclosure, not all of the embodiments. Based on the embodiments in the present disclosure, all other embodiments obtained by those ordinary skilled in the art without contributing creative work shall fall within the protection scope of the present disclosure.

The core of the present disclosure is to provide a metal surface modification apparatus. The metal surface modification apparatus may perform various types of modification treatment, and is convenient to use and relatively high in applicability.

Referring to FIG. 1, FIG. 1 is a schematic diagram of a metal surface modification apparatus according to the present disclosure.

The metal surface modification apparatus according to the present disclosure structurally includes a particle and solution mixing and circulating system, a rotating platform, an electrophoresis system and a temperature control apparatus.

The particle and solution mixing and circulating system is used for providing nanoparticle solution (hereinafter referred to as the solution) for a workpiece. The particle and solution mixing and circulating system is used for depositing nano-scale particles in the solution to the workpiece through a natural deposition method. The rotating platform is used for fixing the workpiece and driving the workpiece to rotate. The particle and solution mixing and circulating system provide the nanoparticle solution for the rotating workpiece, thereby realizing deposition of a spin-coating method. Namely, the rotating platform cooperates with the particle and solution mixing and circulating system to deposit the nano-scale particles in the solution to the workpiece through the spin-coating method. The electrophoresis system is used for depositing the nanoparticle solution in the particle and solution mixing and circulating system to a surface of the workpiece according to an electrophoretic effect. The electrophoretic effect of the electrophoresis system may increase a deposition speed in the solution and improve the deposition efficiency. In addition, an electrophoresis deposition technology has the advantages of convenience in control, no special requirement for types of particles and surface states of the particles and the like, so that migration and adsorption of the mixed micro-nano particles may be performed on any irregular metal surfaces such as a plane, a curved surface, a boss and a groove, or different types of particles may be migrated or adsorbed for multiple times. It should be noted that electrophoresis plays the role of pulling and accelerating deposition of ultrafine particles. The temperature control apparatus is used for changing a surface temperature of the workpiece to realize hydrophilic and hydrophobic modification through melting and self-assembling of the particles on the surface of the workpiece.

Optionally, the particle and solution mixing and circulating system, the rotating platform, the electrophoresis system and the temperature control apparatus may be connected with an integrated control cabinet 14, so that the integrated control cabinet 14 realizes integrated control over the above-mentioned apparatuses.

The metal surface modification apparatus provided by the present disclosure may perform hydrophilic and hydrophobic modification treatment on a metal surface by combining one or more different processes. The natural deposition method, the spin-coating method or an electrophoretic deposition method may be used for assisting nanoparticles in surface treatment of any irregular metal surfaces such as a plane, a curved surface, a boss and a groove, so as to obtain an ordered micro particle arrangement on the metal surfaces to realize the surface modification. A binding force of the nano-scale modified particles and the surface of the workpiece 6 may be further enhanced by changing the surface temperature of the workpiece through heating equipment.

On the basis of the above-mentioned embodiments, the particle and solution mixing and circulating system includes a particle and solution mixing container and one or more of a vibration apparatus, a magnetic stirring apparatus, a suspension suction apparatus and a solution circulating apparatus. The particle and solution mixing container is provided with a suction pipe and a suction pipe clamp which are used for providing the nanoparticle solution for the workpiece, and the suction pipe is used for sucking the nanoparticle solution to the surface of the workpiece.

On the basis of the above-mentioned embodiments, to achieve the above-mentioned electrophoretic effect, the electrophoresis system specifically includes an electrophoresis-aided cathode and an electrophoresis-aided system. The electrophoresis-aided cathode is connected with the suction pipe. An electrophoresis-aided cathode clamp of the electrophoresis-aided cathode is connected to a machine tool main shaft. The machine tool main shaft is used for controlling a distance between the electrophoresis-aided cathode and the workpiece. The output of the electrophoresis-aided system is connected with the electrophoresis-aided cathode and the workpiece respectively. The electrophoresis-aided system outputs a voltage, and sends the voltage to the electrophoresis-aided cathode and the workpiece 6 respectively. It should be noted that an electric field is formed between the electrophoresis-aided cathode and the workpiece 6 to facilitate deposition of the nano-scale particles. In the present embodiment, the electrophoresis-aided system is adopted to provide the electric field, so that a safe and stable electric field environment may be guaranteed.

On the basis of any one of the above-mentioned embodiments, the electrophoresis-aided cathode clamp is connected with the machine tool main shaft. The machine tool main shaft controls a distance between the electrophoresis-aided cathode clamp and the workpiece.

Optionally, alternating current or direct current power is fed to the electrophoresis-aided cathode and the workpiece 6 (or a clamp of the workpiece) during processing, so as to form an assistant electric field between the workpiece 6 and the electrophoresis cathode to assist the particles in ordered deposition and improve the deposition efficiency.

In one specific embodiment, the machine tool main shaft 4 is connected with the particle and solution mixing and circulating system 2. The main shaft 4 is connected with the suction pipe clamp to control a distance between the suction pipe clamp and the workpiece, thereby affecting the particle deposition efficiency.

The machine tool main shaft 4 may be combined with the particle and solution mixing and circulating system 2, so that a mixed solution is sucked to the surface of the workpiece 6 from the particle and solution mixing and circulating system 2 through the suction pipe clamp connected with the main shaft 4, or the mixed solution may be placed on the surface of the workpiece 6 at one time or multiple times.

Optionally, a plurality of workpieces 6 may be combined and matched with the electrophoresis-aided cathode clamp 5, and different cathodes may be switched on line, i.e., different workpieces 6 are switched, to form electrophoresis-aided electric fields together with different workpieces 6, thereby realizing electrophoresis-aided deposition.

To facilitate adjustment of the position of the workpiece 6 and avoid such a phenomenon that the position may not be finely adjusted after the workpiece is fixed, on the basis of any one of the above-mentioned embodiments, the rotating platform for placing the workpiece 6 is arranged on a micro three-dimensional motion platform capable of moving along three dimensional directions. The micro three-dimensional motion platform corresponds to a vertical position of the machine tool main shaft.

A processing tank 7 for fixing the workpiece 6 is mounted on the micro three-dimensional motion platform 11. A workpiece clamp 8 is mounted in the processing tank to mount the workpiece 6 to be processed in the processing tank for surface modification treatment. The micro three-dimensional motion platform 11 may enable the processing tank 7 to do directed motion accurately, thereby guaranteeing relative positions of the processing tank 7 and the main shaft 4 and accurately placing the solution onto the workpiece 6 before the treatment.

On the basis of any one of the above-mentioned embodiments, the metal surface modification apparatus further includes a movable mask, used for covering part of the surface of the workpiece to realize partial insulation treatment. The movable mask is specifically a movable mask made of insulating colloid, such as a PDMS (polydimethylsiloxane) colloid mask. Of course, the movable mask may be a hard film or a soft film. The movable mask covers and presses the workpiece to realize the partial insulation treatment for the workpiece. The solution is placed on a metal workpiece to be processed, and an ordered micro particle arrangement is obtained on the surface of the metal workpiece through an electrophoresis-aided method. A nonconductive part of the movable mask may not have an electric field force effect on the micro particles, so that no electrophoretic effect is achieved on the micro particle deposition. The micro particles are only deposited on exposed parts of the workpiece, so that only part of the surface is modified. Shapes of part of hydrophilic and hydrophobic regions may be changed by changing the shape of a template. Hydrophilic and hydrophobic structures on the surfaces of different regions may be changed by changing different positions of a mask plate.

The movable mask and a control system 9 may be mounted on the processing tank 7. Relative positions of the movable mask and the workpiece 6 are controlled, and the movable mask and the workpiece 6 are mutually pressed during processing, so as to achieve surface modification effects, in different shapes and different positions, on the surfaces of part of the regions of the workpiece.

On the basis of any one of the above-mentioned embodiments, the temperature control apparatus includes a vacuum control module or an auxiliary gas control module. The temperature control apparatus is also called a vacuum and temperature control system 13 capable of guaranteeing inside temperature control and guaranteeing an inside vacuum degree during working, or other types of auxiliary gas are fed to meet a need during surface modification of the metal workpiece. In addition, a vacuum degree and a temperature also may be observed during adjustment.

Optionally, the auxiliary control system of the electrophoresis system, the rotating platform and the particle and solution mixing and circulating system are all connected with the integrated control cabinet.

In addition, the auxiliary control system may be integrated on the machine tool, or arranged on a worktable.

On the basis of any one of the above-mentioned embodiments, the metal surface modification apparatus further includes a CCD (Charge Coupled Device) video detection system used for detecting a deposition condition on the surface of the workpiece and a distribution condition of particles in a molten state. The CCD video detection system 3 is integrated on the processing machine tool 1, and may detect the deposition condition on the surface of the workpiece 6 and the distribution condition of the particles in the molten state.

In any one of the above-mentioned embodiments, the integrated control cabinet 14 may be placed on the right side of the worktable of the machine tool 1. The integrated control cabinet 14 integrates control programs of all the systems of the present disclosure, so that operation of all the processes of the present disclosure may be guaranteed.

In any one of the above-mentioned embodiments, required nanoparticles are put into the particle and solution mixing and circulating system 2 at first for full mixing according to specific needs of a required processing technology. Then, the metal workpiece 6 to be processed is placed into the processing tank 7 and is clamped with a workpiece clamp 8. The integrated control cabinet 14 controls the micro three-dimensional motion platform 11 and the machine tool main shaft 4, and the solution is placed on the workpiece 6. The auxiliary electric field may be formed through the electrophoresis-aided system 12 for surface modification processing. Meanwhile, the relative positions of the movable mask and the workpiece 6 may be controlled, and the movable mask and the workpiece 6 are mutually pressed during processing, so as to achieve the surface modification effects, in different shapes and at different positions, on the surfaces of part of the regions of the workpiece. In addition, the spin-deposition method for the particles may be realized through a rotation control system 10.

During processing, the particles may be observed through the CCD online monitoring system 3, and then the workpiece 6 is put into the vacuum and temperature control system 13 for heating treatment. Processing conditions are controlled to finally realize the hydrophilic and hydrophobic modification for the surface of the metal workpiece 6.

In addition to the main structures of the metal surface modification apparatuses provided by all the above-mentioned embodiments, structures of all the other parts of the metal surface modification apparatus refer to the prior art, and will not be repeated herein.

All the embodiments in the description are described in a progressive way. Each embodiment emphasizes on differences from other embodiments, and same or similar parts of the embodiments refer to one another.

The metal surface modification apparatus according to the present disclosure is described above in detail. Specific examples are used herein for describing the principle and the implementation modes of the present disclosure. Descriptions of above embodiments are only used for helping to understand methods and core ideas of the present disclosure. It should be noted that those ordinary skilled in the art can also make several improvements and modifications to the present disclosure without departing from the principle of the present disclosure. These improvements and modifications shall also fall within the protection scope of claims of the present invention.

We claim:

1. A metal surface modification apparatus, comprising:
a particle and solution mixing and circulating system, used for providing nanoparticle solution for a workpiece;
a rotating platform, used for fixing the workpiece and driving the workpiece to rotate;
an electrophoresis system, used for depositing particles in the nanoparticle solution in the particle and solution mixing and circulating system to a surface of the workpiece according to an electrophoretic effect; and
a temperature control apparatus, used for changing a surface temperature of the workpiece.

2. The metal surface modification apparatus according to claim 1, wherein the particle and solution mixing and circulating system comprises:
a particle and solution mixing container, provided with a suction pipe and a suction pipe clamp which are used for providing the nanoparticle solution for the workpiece, wherein the suction pipe is used for sucking the nanoparticle solution to the surface of the workpiece; and
one or more of a vibration apparatus, a magnetic stirring apparatus, a suspension suction apparatus and a solution circulating apparatus.

3. The metal surface modification apparatus according to claim 2, wherein the electrophoresis system comprises:
an electrophoresis-aided cathode clamp connected to an electrophoresis-aided cathode, wherein the electrophoresis-aided cathode is arranged on the electrophoresis-aided cathode clamp, the electrophoresis-aided cathode clamp of the electrophoresis-aided cathode is connected to a machine tool main shaft, and the machine tool main shaft is used for controlling a distance between the electrophoresis-aided cathode and the workpiece; and
an electrophoresis-aided system, wherein an output of the electrophoresis-aided system is connected with the electrophoresis-aided cathode and the workpiece respectively.

4. The metal surface modification apparatus according to claim 1, wherein the rotating platform is arranged on a micro three-dimensional motion platform capable of moving along three dimensional directions; and the micro three-dimensional motion platform corresponds to a vertical position of the machine tool main shaft.

5. The metal surface modification apparatus according to claim 4, wherein the metal surface modification apparatus further comprises a movable mask used for covering part of the surface of the workpiece to realize partial insulation treatment; and the movable mask is a movable insulating mask.

6. The metal surface modification apparatus according to claim 5, wherein the temperature control apparatus comprises a vacuum control module or an auxiliary gas control module.

7. The metal surface modification apparatus according to claim 6, wherein an auxiliary control system of the electrophoresis system, the rotating platform and the particle and solution mixing and circulating system are connected with an integrated control cabinet.

8. The metal surface modification apparatus according to claim 7, wherein the auxiliary control system is integrated on a machine tool.

9. The metal surface modification apparatus according to claim 8, wherein the metal surface modification apparatus further comprises a CCD (Charge Coupled Device) video detection system used for detecting a deposition condition on the surface of the workpiece and a distribution condition of particles in a molten state.
